(19) United States
(12) Patent Application Publication
(10) Pub. No.: US 2014/0059305 A1
(43) Pub. Date: Feb. 27, 2014

(54) MANAGEMENT APPARATUS, STORAGE DEVICE, AND INITIALIZATION METHOD

(71) Applicant: FUJITSU LIMITED, Kawasaki-shi (JP)

(72) Inventors: Norio KONDO, Setagaya (JP); Kinya Saito, Kawasaki (JP)

(73) Assignee: FUJITSU LIMITED, Kawasaki (JP)

(21) Appl. No.: 13/919,264

(22) Filed: Jun. 17, 2013

(30) Foreign Application Priority Data
Aug. 21, 2012 (JP) 2012-182602

(51) Int. Cl. G06F 12/00

(52) U.S. Cl. CPC G06F 12/00
USPC 711/154

(57) ABSTRACT

A management apparatus that performs initialization of a storage region of a storage medium is described. The management unit includes a first storage area that stores a first information representing an initialization status of the storage region of the storage medium, a second storage area that stores a second information representing an initialization progress status of the storage region of the storage medium, an initializing unit that performs initialization of the storage medium based on the second information, and a storage processing unit that updates the first information based on the second information which reflects the initialization progress status.

### CROSS-REFERENCE TO RELATED APPLICATION

This application is based upon and claims the benefit of priority from the prior Japanese Patent Application No. 2012-182602 filed on Aug. 21, 2012, the entire contents of which are incorporated herein by reference.

### FIELD

The embodiments discussed herein are related to a management apparatus, a storage device, and an initialization method.

### BACKGROUND

In accordance with an increase in the capacity of a storage medium such as a hard disk drive (HDD), the storage capacity of a logical volume to be allocated to a user is also increased.

In accordance with this, the time to be taken for formatting (initialization) of a storage area of a storage medium is increased.

Meanwhile, the formatting speed is not increased enough.

For example, in the case where the combination of five near-line HDDs 5 each having three terabytes (TB) forms redundant arrays of inexpensive disks (RAID 5), it takes about four days to complete formatting processing.

The “formatting” represents processing for writing zero data into a “volume” or a “storage pool (including a virtual pool by thin provisioning technology or the like)” of a storage medium 109 (hereinafter, the volume and the storage pool are collectively called “a logical volume”) 110, as illustrated in FIG. 15.

FIG. 15 is a diagram illustrating formatting processing of related art.

In the formatting processing of the related art, a region that has already been zero-cleared is also zero-cleared at the time of formatting. Thus, a wasteful processing time occurs.

Furthermore, at the time of formatting (initializing) a storage medium such as an HDD or the like in a storage device, for example, part of a cache memory 107 provided in a storage device 103 is used as a region 141 in which the formatting status is stored (hereinafter, referred to as a “formatting status storage region”), as illustrated in FIG. 16.

In the formatting status storage region 141, formatting status tables 142-1 and 142-2 representing whether the formatting of logical volumes 110-1 and 110-2 of HDDs 109-1, 109-2, 109-3, and 109-4 in the storage device 103 has been completed (progress status of formatting) are stored.

In FIG. 16, “done” written in the formatting status tables 142-1 and 142-2 represents that formatting of corresponding blocks in the logical volumes 110-1 and 110-2 has been completed.

FIG. 16 is a diagram which illustrates formatting processing of a related art.

In general, in the case of formatting processing for a storage medium, in order to speed up the processing, one or more formatting processes are performed concurrently. Such concurrent processing is called “multiplexing”, and the number of formatting processing operations that are performed concurrently is called the “degree of multiplexing”.

Since the cache memory 107 provided in the storage device 103 is also used to store cache data for operation input/outputs (I/Os), the capacity of the cache memory 107 to be used for management of formatting processing is limited.

Furthermore in accordance with an increase of the capacity of a storage medium, a region of the cache memory 107 to be used for a single formatting processing operation is increased.

As a result, since a certain amount of capacity of the cache memory 107 is to be used for each of storing of the formatting status and operation I/O processing, the capacity of the cache memory 107 to be used for storing of the formatting status is limited. As described above, in order to speed up formatting processing, there is a demand for increasing the degree of multiplexing of formatting processing as much as possible. However, it is difficult to ensure such a region in the cache memory 107.

Meanwhile, in small and medium sized systems, establishing the environment of a storage system in a short period of time and quickly ensuring the original disk access performance is demanded.

However, it may take a long period of time, such as several days, to format all the logical volumes in a storage device, as in the example mentioned above.

Under such circumstances, speeding up the formatting processing for a storage region in a storage device is demanded.

A related art is disclosed, for example, in Japanese Laid-open Patent Publication No. 2005-11317.

### SUMMARY

According to an aspect of the invention, a management apparatus that performs initialization of a storage region of a storage medium is described. The management unit includes a first storage area that stores a first information representing an initialization status of the storage region of the storage medium, a second storage area that stores a second information representing an initialization progress status of the storage region of the storage medium, an initializing unit that performs initialization of the storage medium based on the second information, and a storage processing unit that updates the first information based on the second information which reflects the initialization progress status.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating an example of the configuration of a storage system according to an embodiment;

FIG. 2 is a block diagram illustrating an example of the functional configuration of a formatting processing unit in an embodiment;

FIG. 3 is a diagram illustrating an example of a process performed by the formatting processing unit in an embodiment;

FIG. 4 is a diagram illustrating an example of a process performed by a zero-clearing part of the formatting processing unit in an embodiment;

FIG. 5 is a method illustrating an example of the overview of a process performed by the formatting processing unit in an embodiment;

FIG. 6 is a method illustrating an example of a process of formatting processing performed in the background by the formatting processing unit in an embodiment;

FIG. 7 is a method illustrating an example of a process for an operation I/O performed while formatting is being performed by the formatting processing unit in an embodiment;

FIG. 8 is a diagram illustrating an example of application of a cache memory performed by the formatting processing unit in an embodiment;

FIG. 9 is a method illustrating the process illustrated in FIG. 8;

FIG. 10 is a method illustrating an example of a process performed by the formatting processing unit in the case where a plurality of operation I/Os occur in an embodiment;

FIG. 11 is a diagram illustrating an example of a process performed by the formatting processing unit when an operation I/O occurs in an embodiment;

FIG. 12 is a method illustrating an example of a process performed by a specific range calculating part in an embodiment;

FIG. 13 is a method illustrating an example of a process performed by a specified rate calculating part in an embodiment;

FIG. 14 is a diagram illustrating a process performed by a formatting processing unit in a variation of an embodiment;

FIG. 15 is a diagram illustrating formatting processing in a related art; and

FIG. 16 is a diagram illustrating formatting processing in a related art.

### DESCRIPTION OF EMBODIMENTS

Hereinafter, a management apparatus, a storage device, and an initialization method according to embodiments will be explained with reference to the drawings. The embodiments described below are merely exemplifications, and various modifications and applications of techniques that are not clearly specified in the embodiments are not to be excluded. That is, the embodiments may also be implemented by being modified (for example, combining embodiments and variations, or the like) without departing from the scope of the embodiments.

### (A) Embodiment

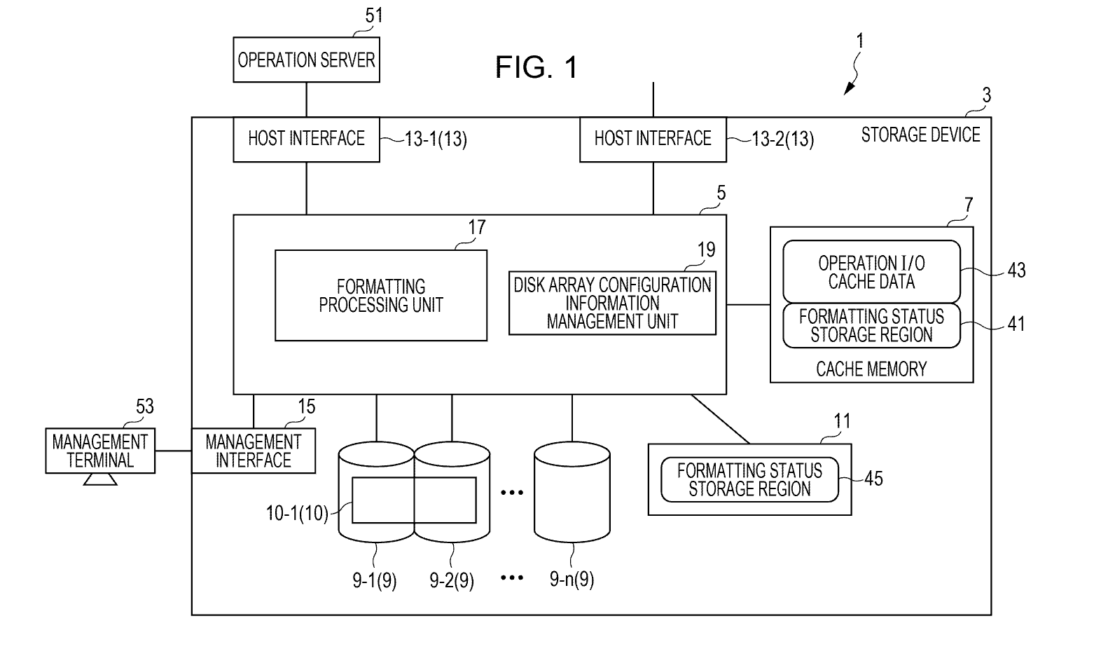

FIG. 1 is a diagram illustrating an example of the configuration of a storage system 1 according to an embodiment.

The storage system 1 includes a storage device 3. At least one operation server (host) 51 and a management terminal 53 are connected to the storage device 3.

The operation server 51 performs writing and reading of data to and from HDDs 9-1, 9-2, . . . , and 9-n (n represents an integer of two or more), which will be described later, of the storage device 3 to which the operation server 51 is connected. The storage device 3 performs data accessing to the HDDs 9-1, 9-2, . . . , and 9-n in accordance with a data access request, and responds to the operation server 51.

The operation server 51 is, for example, a computer (information processing) having a server function, and transmits and receives various data including SCSI commands and responses to and from the storage device 3, using a storage connection protocol. The operation server 51 performs writing and reading of data to and from a storage region in the storage device 3 by transmitting a disk access command, such as read/write, to the storage device 3.

The storage device 3 provides a storage region to the operation server 51 and is connected via a network, which is not illustrated, to the operation server 51 in such a manner that the storage device 3 and the operation server 51 may communicate with each other. The storage device 3 is, for example, a RAID device.

Although for the sake of convenience, the case where one operation server 51 is connected to the storage device 3 is illustrated in FIG. 1, two or more operation servers 51 may be connected to the storage device 3.

The storage device 3 includes, for example, a central processing unit (CPU) 5, a cache memory (second storage area) 7, a plurality of HDDs (storage media) 9-1, 9-2, . . . , and 9-n, a solid state drive (SSD) (first storage area) 11, host interfaces 13-1 and 13-2, and a management interface 15.

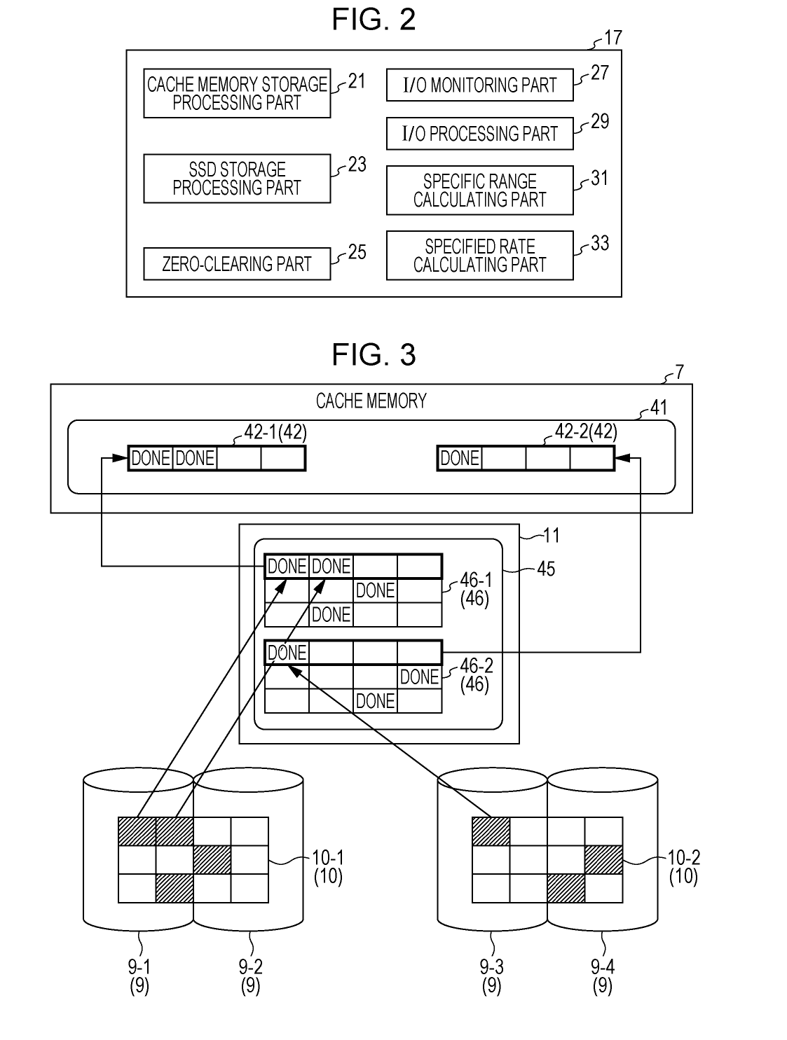

The CPU 5 is a processing unit that performs various types of control and arithmetic operations, and implements various functions by executing a program stored in a read only memory (ROM), which is not illustrated, or the like. In this example, as illustrated in FIG. 1, the CPU 5 functions as a formatting processing unit 17 (management apparatus) when executing an initialization program, which is not illustrated, stored in a ROM, which is not illustrated, or the like. The functional configuration of the formatting processing unit 17 will be described later with reference to FIG. 2.

The CPU 5 includes a disk array configuration information management unit 19, which will be described later.

The cache memory 7 is, for example, a high-speed random accessible memory such as a static random access memory (SRAM). The cache memory 7 stores therein operation I/O cache data 43, and includes a formatting status storage region 41 to be used for formatting processing for the HDDs 9-1, 9-2, . . . , and 9-n, which will be described later. The formatting status storage region 41 stores therein formatting progress status management tables (second information) 42-1, 42-2, and so on (will be described later with reference to FIG. 3) representing whether or not formatting of logical volumes 10-1 and so on of the HDDs 9-1, 9-2, . . . , and 9-n, which will be described later, has been completed (progress status of formatting).

The HDDs 9-1, 9-2, . . . , and 9-n are disk drives providing storage areas. With the combination of the plurality of HDDs 9-1, 9-2, . . . , and 9-n, the storage device 3 functions as the logical volumes 10-1 and so on. Configuration information of the logical volumes 10-1 and so on provided by the HDDs 9-1, 9-2, . . . , and 9-n is managed by the disk array configuration information management unit 19 of the CPU 5.

The SSD 11 is, for example, a high-speed storage unit that employs a flash memory or the like as a storage medium. The SSD 11 includes a formatting status storage region 45 to be used for formatting processing for the HDDs 9-1, 9-2, . . . , and 9-n. The formatting status storage region 45 stores therein formatting status management tables (first information) 46-1, 46-2, and so on (will be described later with reference to FIG. 3) representing whether or not formatting of the logical volumes 10-1 and so on of the HDDs 9-1, 9-2, . . . , and 9-n in the storage device 3 has been completed.

The host interfaces 13-1 and 13-2 are storage connection interfaces connected to the operation server 51 in such a manner that the host interfaces 13-1 and 13-2 and the operation server 51 may communicate with each other. The host interfaces 13-1 and 13-2 are, for example, fiber channel interfaces.

The management interface 15 is a storage connection interface that is connected to the management terminal 53 in such a manner that the management interface 15 and the management terminal 53 may communicate with each other. The management interface 15 is, for example, a LAN card.

The management terminal 53 is an information processing device including a CPU, a RAM, a ROM, and an HDD, which are not illustrated. With the use of the management terminal 53, an operator who performs operations for introduction and maintenance of the storage device 3 performs various management operations for the storage device 3.

Hereinafter, regarding reference signs representing HDDs, reference sign 9-1, 9-2, . . . , or 9-n is used when one of the plurality of HDDs is specified. Meanwhile, reference sign 9 represents any HDD.

Furthermore, regarding reference signs representing logical volumes, reference sign 10-1 or the like is used when one of the plurality logical volumes is specified. Meanwhile, reference sign 10 represents any logical volume.

Furthermore, regarding reference signs representing host interfaces, reference sign 13-1 or 13-2 is used when one of the plurality of host interfaces is specified. Meanwhile, reference sign 13 represents any host interface.

Furthermore, regarding reference sings representing formatting progress status management tables (see FIG. 3) in the cache memory 7, reference sign 42-1, 42-2, or the like is used when one of the plurality of formatting progress status management tables is specified. Meanwhile, reference sign 42 represents any formatting progress status management table.

Furthermore, regarding reference signs representing formatting status management tables (see FIG. 3) in the SSD 11, reference sign 46-1, 46-2, or the like is used when one of the plurality of formatting status management table is specified. Meanwhile, reference sign 46 represents any formatting status management table.

The functional configuration of the formatting processing unit 17 will now be explained with reference to FIG. 2.

FIG. 2 is a block diagram illustrating an example of the functional configuration of the formatting processing unit 17 according to an embodiment.

The formatting processing unit 17 includes a cache memory storage processing part (second storage processing part) 21, an SSD storage processing part (first storage processing part) 23, a zero-clearing part (initialization part) 25, an I/O monitoring part (input/output monitoring part) 27, an I/O processing part (input/output processing part) 29, a specific range calculating part (calculating part) 31, and a specified rate calculating part (calculating part) 33.

The cache memory storage processing part 21 writes the formatting progress status management table 42, in which information of the progress status of some blocks of the logical volume 10 in the HDD 9 representing whether or not formatting has been completed, into the cache memory 7. Hereinafter, a block is referred to as a “processing block”.

FIG. 3 is a diagram illustrating an example of processing performed by the formatting processing unit 17 in an embodiment. In FIG. 3, “done” in the formatting progress status management table 42 represents that formatting of corresponding blocks in the logical volume 10 has been completed.

Furthermore, after formatting processing for all the blocks stored in the formatting progress status management table 42 has been completed, the cache memory storage processing part 21 causes the contents of the formatting progress status management table 42 to be reflected in a corresponding formatting status management table 46 in the SSD 11. Then, the formatting progress status management table 42 is deleted, and the storage region of the cache memory 7 used by the formatting progress status management table 42 is released.

The SSD storage processing part 23 writes the formatting status management table 46, in which information of all the processing blocks of the logical volume 10 in the HDD 9 representing whether or not formatting has been completed is registered, into the SSD 11. Similar to the formatting progress status management table 42, “done” in the formatting status management table 46 in FIG. 3 represents that formatting of corresponding blocks in the logical volume 10 has been completed.

The zero-clearing part 25 writes zero data (all zero) into a storing region allocated to the logical volume 10 in the HDD 9. The zero-clearing part 25 multiplexes formatting processing by processing a plurality of logical volumes 10 at the same time (concurrently). The zero-clearing part 25 may multiplex formatting processing by formatting a plurality of regions in the same logical volume 10 at the same time.

The I/O monitoring part 27 monitors whether or not an operation I/O from the operation server 51 (see FIG. 1) is issued while formatting processing is in progress.

In the case where an operation I/O from the operation server 51 is detected by the I/O monitoring part 27 while formatting processing is in progress, the I/O processing part 29 processes the operation I/O.

In the case where not initial formatting of the entire logical volume 10 but formatting of only part of the logical volume 10 is to be performed, the specific range calculating part 31 calculates the capacity of a region for which initial formatting is to be performed in the entire logical volume 10 (hereinafter, this range is referred to as a “specific value range”).

In the case where not initial formatting of the entire logical volume 10 but only formatting of part of the logical volume 10 is to be performed, the specified rate calculating part 33 calculates the rate of a region for which initial formatting is to be performed (hereinafter, this range is referred to as a “specified rate”).

Next, a process performed by the formatting processing unit 17 will be explained with reference to FIG. 3.

The formatting processing unit 17 stores and expands information of the entire logical volume 10 as the formatting status management table 46 into the SSD 11. The formatting processing unit 17 also reads part of the formatting status management table 46 and stores and expands the read part of the formatting status management table 46 as the formatting progress status management table 42 into the cache memory 7.

For example, only processing blocks belonging to the same segment as the processing block for which formatting processing is currently in progress of the formatting status management table 46 is stored into the formatting progress status management table 42.

As described above, only information relating to the progress status of a processing block for which formatting processing is currently in progress is stored as the formatting progress status management table 42 into the cache memory 7. Thus, the storage region of the cache memory 7 used for management of the progress status is reduced, and formatting progress status management tables 42 for a plurality of logical volumes (a plurality of HDDs 9) may be expanded into the cache memory 7. Therefore, formatting processing for a plurality of logical volumes (a plurality of HDDs) may be performed at the same time. Consequently, since the number of formatting processing operations that may be performed at the same time is increased, the degree of multiplexing of formatting processing is increased.

Even if the number of times accessed to the formatting status management table 46 is increased for the purpose of creation and deletion of the formatting progress status management table 42, since the SSD 11 having a high-speed access performance is used, the performance of operation I/O to the other logical volumes 10 is not deteriorated.

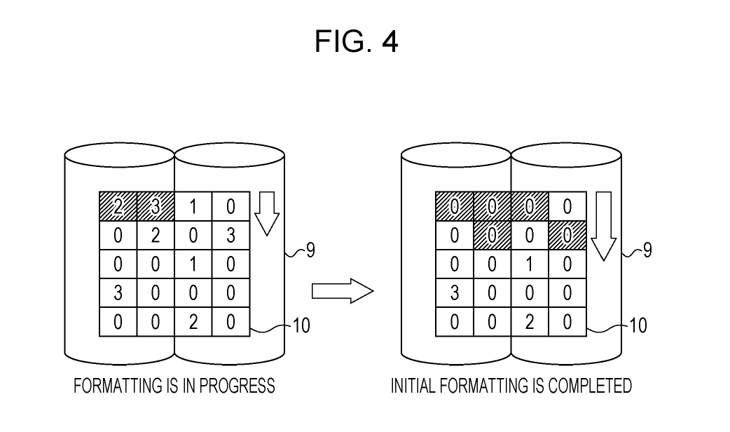

Next, processing performed by the zero-clearing part 25 of the formatting processing unit 17 will be explained with reference to FIG. 4.

FIG. 4 is a diagram illustrating an example of processing performed by the zero-clearing part 25 of the formatting processing unit 17 according to an embodiment.

The zero-clearing part 25 performs formatting by writing, for example, zero data to individual processing blocks of the logical volume 10 of the HDD 9 in order from the beginning. At this time, a block to which all-zero data has already been written (a block of all zero: represented by “0” in FIG. 4) is skipped, as illustrated in FIG. 4.

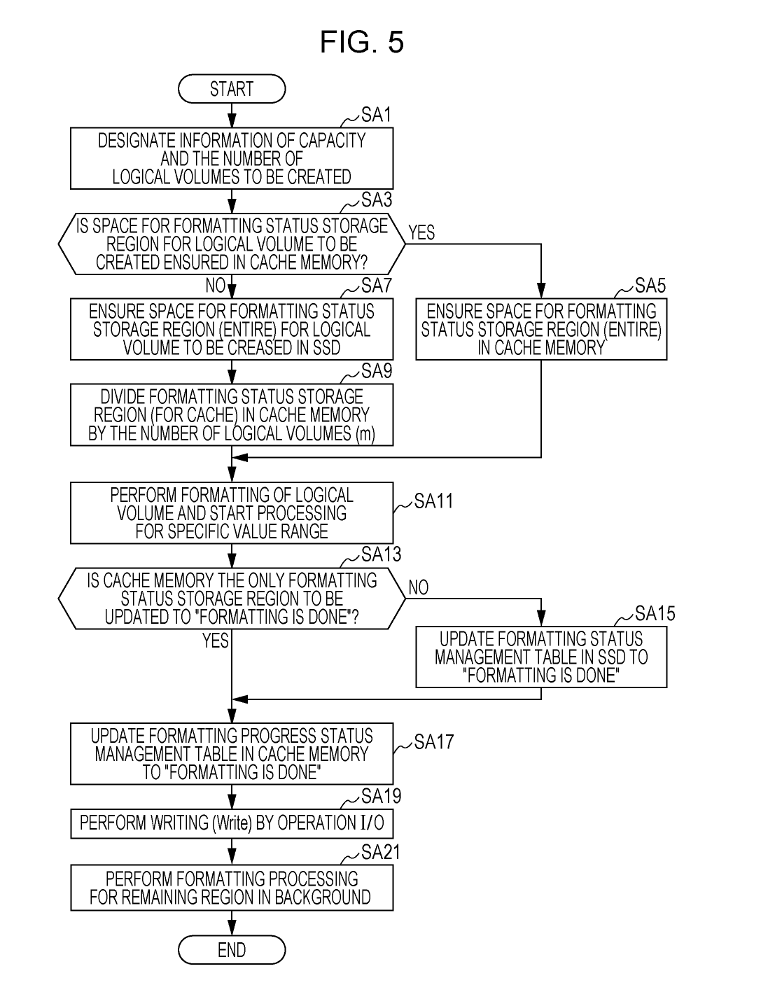

Next, the overview of a process performed by the formatting processing unit 17 will be explained with reference to FIG. 5.

FIG. 5 is a method illustrating an example of the overview of a process performed by the formatting processing unit 17 according to an embodiment.

In step SA1, an operator who performs a formatting operation for the storage device 3 designates the capacity and the number of logical volumes 10 to be created.

Next, in step SA3, the cache memory storage processing part 21 determines whether or not the space for a formatting status storage region in which a formatting status management table for the logical volume 10 to be created is to be stored is ensured in the formatting status storage region 41 in the cache memory 7.

In the case where the space for the formatting status storage region is ensured (see YES route for step SA3), the cache memory storage processing part 21 stores the formatting status management table into the formatting status storage region 41 in the cache memory 7 in step SA5. The formatting status management table is used as the formatting progress status management table 42, and the process proceeds to step SA11, which will be described later. Even in the case where the space for a cache is ensured, if a flag indicating multiplexing processing exists, the process may proceed to step SA7.

Meanwhile, in the case where the space for the formatting status storage region is not ensured (see NO route for step SA3), the SSD storage processing part 23 stores the formatting status management table 46 into the formatting status storage region 45 in the SSD 11 in step SA7. In step SA9, the cache memory storage processing part 21 divides the formatting status storage region 41 of the cache memory 7 into the total number m (m represents an integer of 2 or more) of the logical volumes 10.

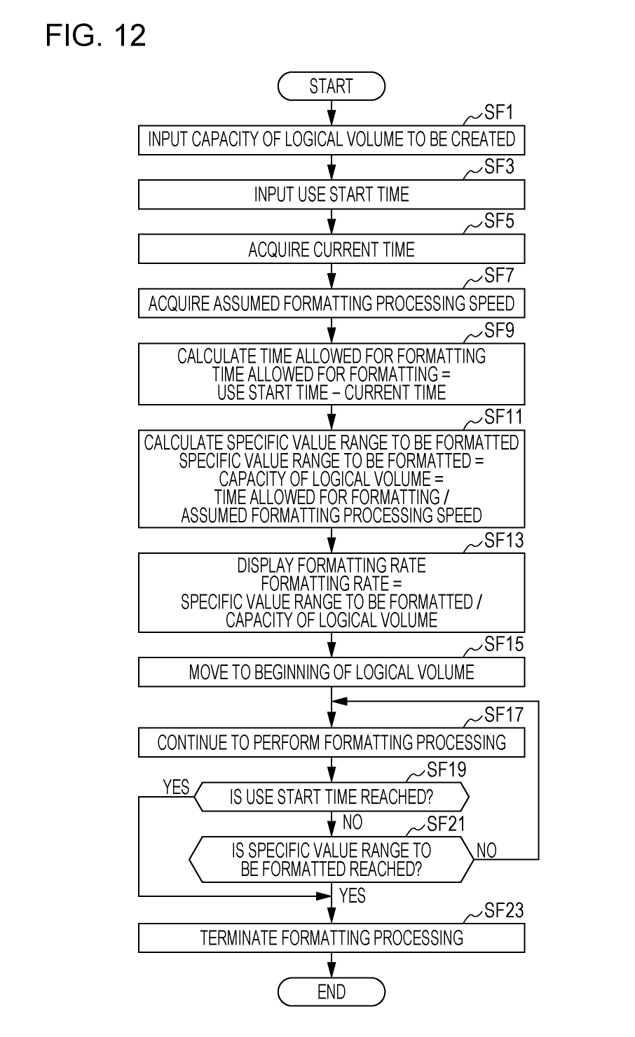

Next, in step SA11, the zero-clearing part 25 starts formatting processing for a specific value range of the logical volume 10. A method for calculating the specific value range will be described later with reference to FIG. 12.

Next, in step SA13, the zero-clearing part 25 determines whether or not only the formatting status of the formatting status storage region 41 in the cache memory 7 is to be updated to “done”.

In the case where the process has undergone step SA9 and the formatting status management table 46 in the SSD 11 as well as the formatting progress status management table 42 in the formatting status storage region 41 is to be updated (see NO route for step SA13), the process proceeds to step SA15. Then, the SSD storage processing part 23 updates the formatting status of the formatting status management table 46 in the formatting status storage region 45 in the SSD 11 to “done”, and the process proceeds to step SA17, which will be described later.

Meanwhile, in the case where the process has undergone step SA5, since only the formatting status of the format status management table in the cache memory 7 that is used a formatting progress status management table is to be updated (see YES route for step SA13), the process proceeds to step SA17.

In step SA17, the cache memory storage processing part 21 updates the formatting status of the formatting progress status management table 42 in the formatting status storage region 41 in the cache memory 7 to “done”.

Then, in step SA19, the I/O monitoring part 27 detects an operation I/O, and the I/O processing part 29 processes the detected operation I/O (for example, performs writing).

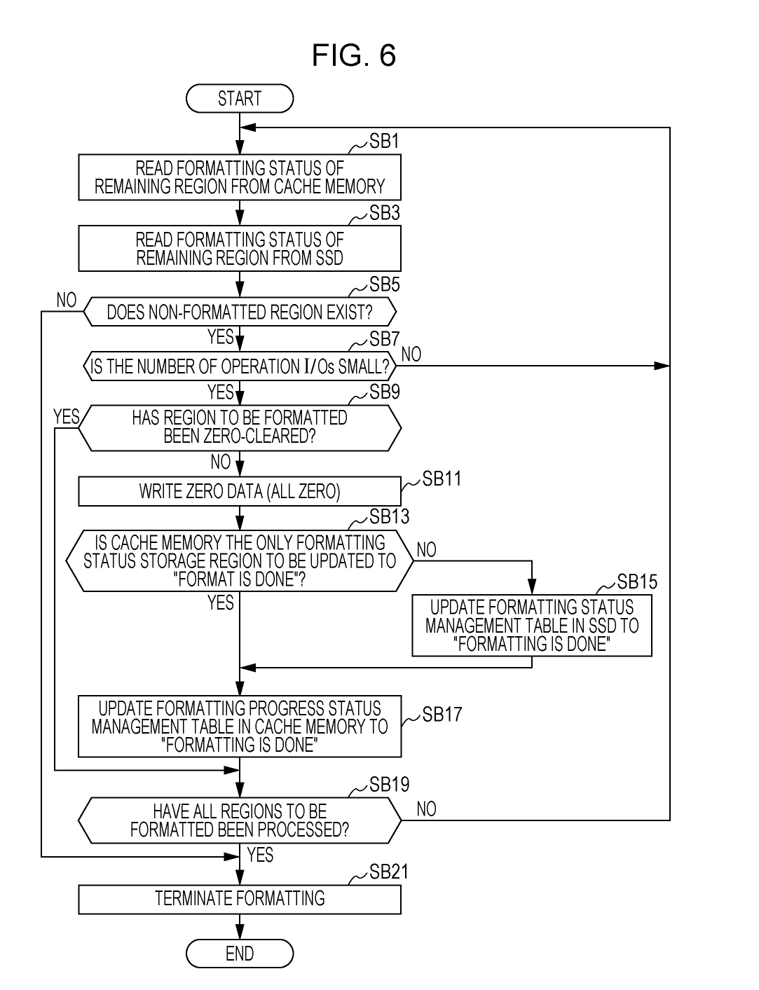

Concurrently with step SA19, in step SA21, the zero-clearing part 25 performs, in the background, formatting processing for the remaining regions of the logical volume 10 to be formatted, and the process is terminated. The details of the background processing will be explained with reference to FIG. 6.

FIG. 6 is a method illustrating an example of a process of formatting processing performed in the background by the formatting processing unit 17 according to an embodiment.

In step SB1, the zero-clearing part 25 reads the formatting status of a remaining region of the logical volume 10 to be formatted from the formatting progress status management table 42 in the cache memory 7.

Then, in step SB3, the zero-clearing part 25 reads the formatting status of the remaining region of the logical volume 10 to be formatted from the formatting status management table 46 in the SSD 11.

Then, in step SB5, the zero-clearing part 25 determines whether or not a non-formatted region remains in the logical volume 10 to be formatted.

In the case where formatting of all the regions has been completed (see NO route for step SB5), the process proceeds to step SB21. In step SB21, the formatting processing is completed. Then, the process is terminated.

Meanwhile, in the case where a non-formatted region exists (see YES route for step SB5), the I/O monitoring part 27 determines whether or not the number of operation I/Os occurring in the storage device 3 is small in step SB7. The determination as to whether or not the number of operation I/Os is small is performed, for example, by comparing, by the I/O monitoring part 27, the number of operation I/Os with a specific threshold at the time when the determination is performed.

In the case where the number of operation I/Os occurring in the storage device 3 is large (see NO route for step SB7), the process returns to step SB1

Meanwhile, in the case where the number of operation I/Os occurring in the storage device 3 is small (see YES route for step SB7), the zero-clearing part 25 determines whether or not a region of the logical volume 10 to be formatted has already been zero-cleared (all-zero) in step SB9.

In the case where the region to be formatted has already been zero-cleared (see YES route for step SB9), the process proceeds to step SB19, which will be described later.

Meanwhile, in the case where the region to be formatted has not been zero-cleared (see NO route for step SB9), the zero-clearing part 25 writes zero data (all zero) into the region and performs formatting in step SB11.

In step SB13, the zero-clearing part 25 determines whether or not only the formatting status of the formatting status storage region 41 in the cache memory 7 is to be updated to “done”.

In the case where the formatting status management table 46 in the SSD 11 as well as the formatting status storage region 41 in the cache memory 7 is to be updated (see NO route for step SB13), the process proceeds to step SB15. The SSD storage processing part 23 updates the formatting status of the formatting status management table 46 in the formatting status storage region 45 in the SSD 11 to “done” in step SB15, and the process proceeds to step SB17.

Meanwhile, in the case where only the formatting status of the formatting progress status management table 42 in the cache memory 7 is to be updated to “done” (see YES route for step SB13), the process proceeds to step SB17.

In step SB17, the cache memory storage processing part 21 updates the formatting status of the formatting progress status management table 42 in the formatting status storage region 41 in the cache memory 7 to “done”.

In step SB19, the zero-clearing part 25 determines whether or not all the regions to be formatted have been processed.

In the case where an unprocessed region to be formatted exists (see NO route for step SB19), the process returns to step SB1.

In the case where all the regions to be formatted have been processed (see YES route for step SB19), the formatting processing is completed in step SB21.

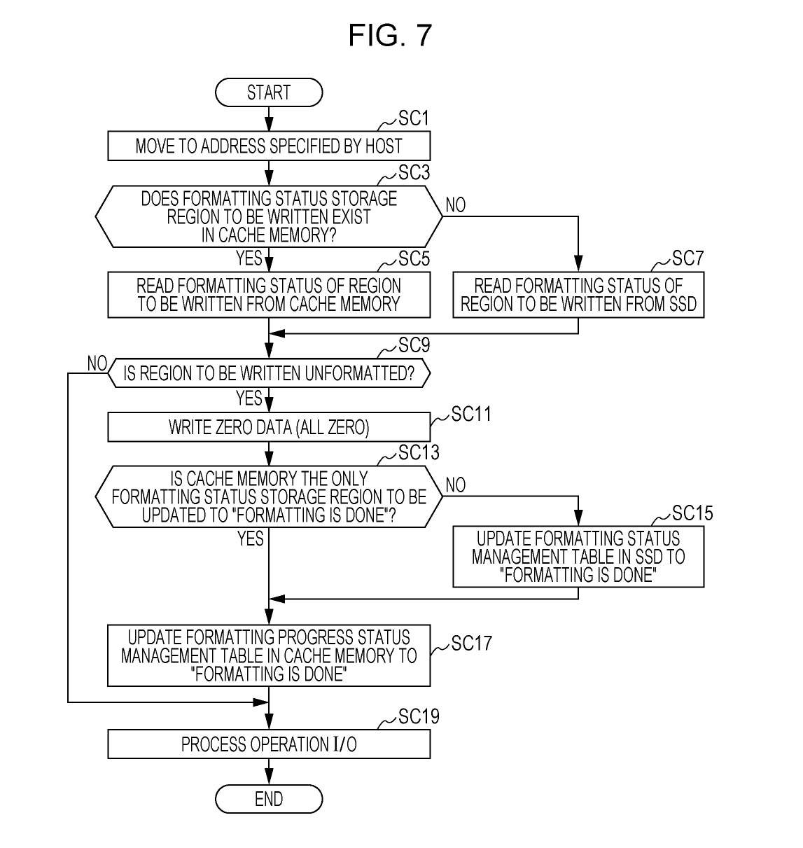

Next, a process performed in the case where an operation I/O from the operation server 51 is issued while formatting is being performed by the formatting processing unit 17 will be explained with reference to FIG. 7.

FIG. 7 is a method illustrating an example of a process for an operation I/O while formatting is being performed by the formatting processing unit 17 in an embodiment.

In step SC1, when the I/O monitoring part 27 detects a writing instruction from the operation server 51, the formatting processing unit 17 moves to an address in the logical volume 10 to which writing is designated.

In step SC3, the formatting processing unit 17 determines whether or not a formatting status storage region 41 corresponding to a region to which writing (Write) is to be performed exists in the cache memory 7.

In the case where the formatting status storage region 41 corresponding to a region to which writing is to be performed exists in the cache memory 7 (see YES route for step SC3), the zero-clearing part 25 reads the formatting progress status management table 42 for the region to which writing is to be performed from the formatting status storage region 41 in the cache memory 7 in step SC5.

In the case where a formatting status storage region 41 corresponding to the region to which writing is to be performed does not exist in the cache memory 7 (see NO route for step SC3), the zero-clearing part 25 reads a formatting status management table 46 for the region to which writing is to be performed from the formatting status storage region 45 in the SSD 11 in step SC7.

Next, in step SC9, the zero-clearing part 25 determines whether or not the region to which writing is to be performed, which is designated by the operation server 51, is unformatted.

In the case where the region to which writing is to be performed is unformatted (see YES route for step SC9), the zero-clearing part 25 writes zero data (all zero) to the region and performs formatting in step SC11.

In the case where the region to which writing is to be performed has been formatted (see NO route for step SC9), the process proceeds to step SC19, which will be described later.

Next, in step SC13, the zero-clearing part 25 determines whether or not only the formatting status of the formatting status storage region 41 in the cache memory 7 is to be updated to “done”.

In the case where the formatting status management table 46 in the SSD 11 as well as the formatting status storage region 41 in the cache memory 7 is to be updated (see NO route for step SC13), the process proceeds to step SC15. Then, the SSD storage processing part 23 updates the formatting status of the formatting status management table 46 in the formatting status storage region 45 in the SSD 11 to “done”, and the process proceeds to step SC17.

Meanwhile, in the case where only the formatting status of the formatting progress status management table 42 in the cache memory 7 is to be updated to “done” (see YES route for step SC13), the process proceeds to step SC17.

In step SC17, the cache memory storage processing part 21 updates the formatting status of the formatting progress status management table 42 in the formatting status storage region 41 in the cache memory 7 to “done”.

Then, in step SC19, the I/O processing part 29 processes the operation I/O, and the process is terminated.

Next, an example of the allocation of the cache memory 7 by the formatting processing unit 17 in an embodiment will be explained.

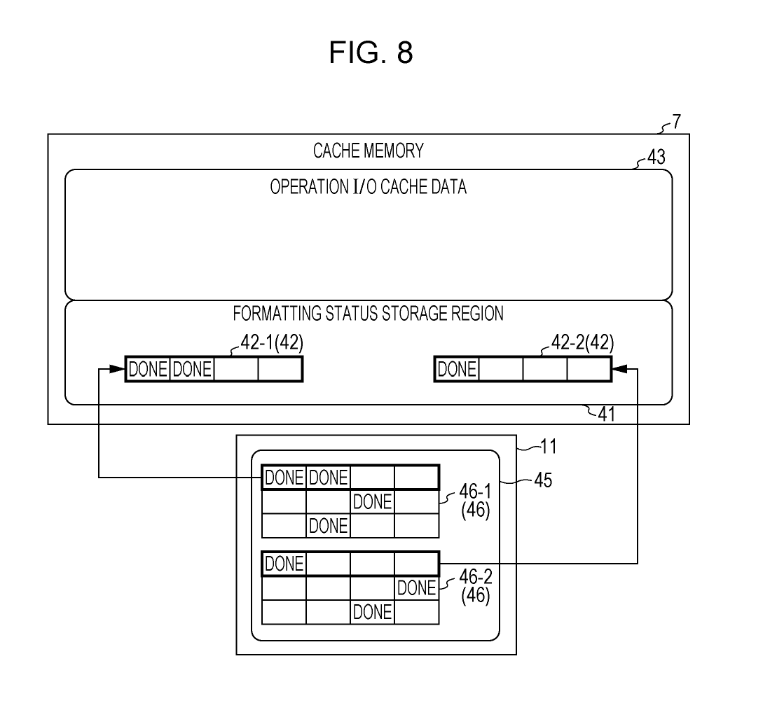

FIG. 8 is a diagram illustrating an example of the allocation of the cache memory 7 by the formatting processing unit 17 in an embodiment.

The SSD storage processing part 23 of the formatting processing unit 17 stores part of the formatting status management table 46 in the SSD 11 into the formatting progress status management table 42 in the cache memory 7. The part corresponds to a processing block belonging to the same segment of the processing block for which formatting processing is currently in progress, as described above.

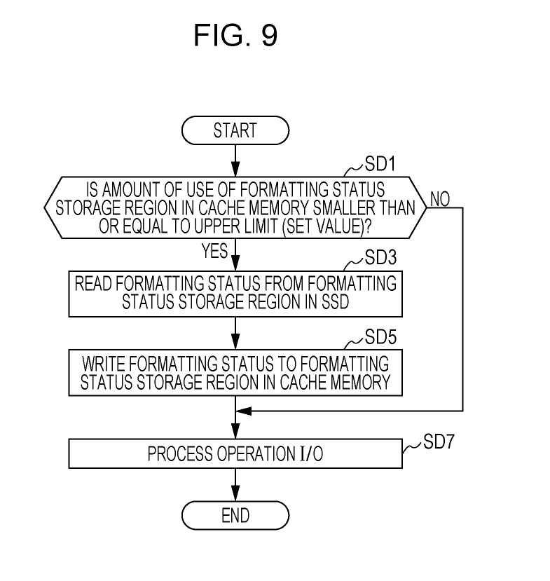

Next, the details of the process will be explained with reference to FIG. 9.

FIG. 9 is a method illustrating the process of FIG. 8.

In step SD1, it is determined whether or not the amount of use of the formatting status storage region 41 in the cache memory 7 is smaller than or equal to an upper limit value (set value). The upper limit value (set value) is, for example, set at the shipment of the storage device 3 from a factory. However, the upper limit value may be changed in a desired manner later by an administrator or an operator. The upper limit value is, for example, designated on the basis of the actual capacity value or the percentage (%) of the amount of use of the formatting status storage region 41 relative to the entire storage capacity of the cache memory 7.

In the case where the amount of use of the formatting status storage region 41 in the cache memory 7 is greater than the upper limit value (see NO route for step SD1), the process proceeds to step SD7, which will be described later.

Meanwhile, in the case where the amount of use of the formatting status storage region 41 in the cache memory 7 is smaller than or equal to the upper limit value (see YES route for step SD1), the zero-clearing part 25 reads the formatting status from the formatting status storage region 45 in the SSD 11 in step SD3.

Then, in step SDS, the cache memory storage processing part 21 writes the formatting status read in step SD3 into the formatting status storage region 41 in the cache memory 7.

Then, in step SD7, the I/O processing part 29 processes the operation I/O, and the process is terminated.

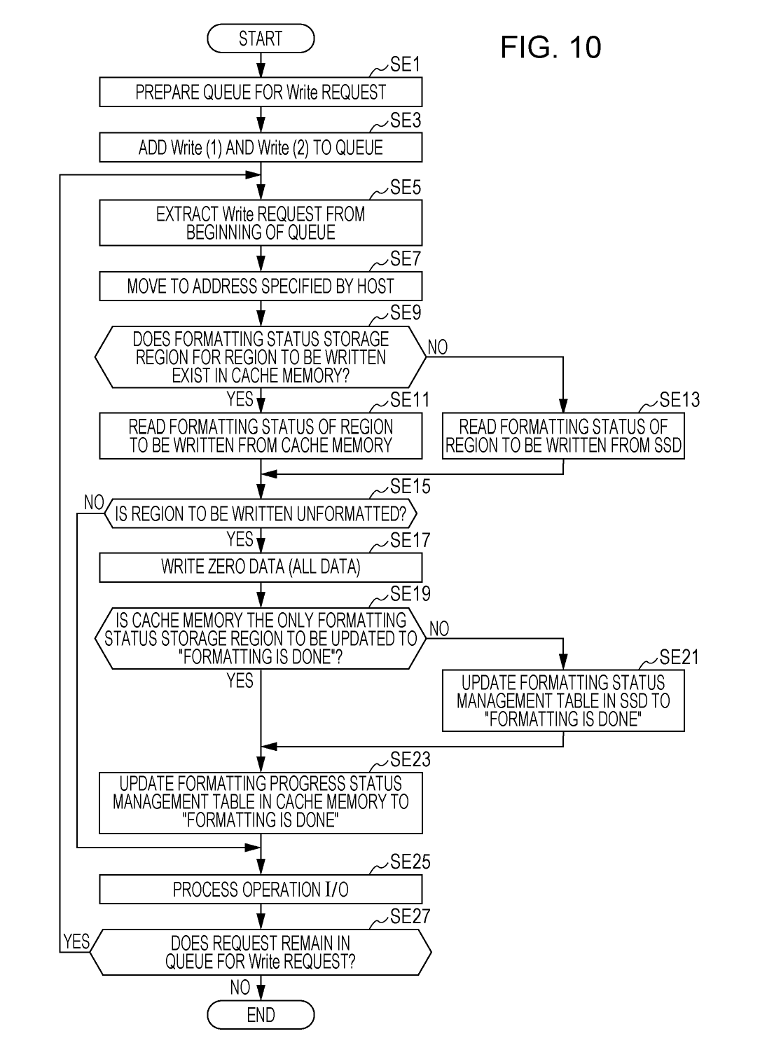

Next, an example of a process performed by the formatting processing unit 17 in the case where a plurality of operation I/Os occur in an embodiment will be explained with reference to FIG. 10.

FIG. 10 is a method illustrating an example of a process performed by the formatting processing unit 17 in the case where a plurality of operation I/Os occur in an embodiment.

Here, the case where two writing requests, Write (1) and Write (2), are generated will be considered.

In step SE1, the I/O processing part 29 creates a queue for a writing request (not illustrated).

Then, in step SE3, the I/O processing part 29 adds Write (1) and Write (2) to the queue.

Then, in step SE5, the I/O processing part 29 extracts a Write request from the beginning of the writing request queue.

In step SE7, the I/O processing part 29 moves to an address specified by the operation server 51 in the writing request.

Then, in step SE9, the zero-clearing part 25 determines whether or not a formatting status storage region 41 corresponding to a region to which writing is to be performed exists in the cache memory 7.

In the case where a formatting status storage region 41 corresponding to the region to which writing is to be performed exists in the cache memory 7 (see YES route for step SE9), the zero-clearing part 25 reads the formatting status of the region to which writing is to be performed from the formatting status storage region 41 in the cache memory 7 in step SE11, and the process proceeds to step SE15.

Meanwhile, in the case where a formatting status storage region 41 corresponding to the region to which writing is to be performed does not exist in the cache memory 7 (see NO route for step SE9), the zero-clearing part 25 reads the formatting status of the region to which writing is to be performed from the formatting status storage region 45 in the SSD 11 in step SE13, and the process proceeds to step SE15.

In step SE15, the zero-clearing part 25 determines whether or not the region to which writing is to be performed is unformatted.

In the case where the region to which writing is to be performed has been formatted (see NO route for step SE15), the process proceeds to step SE25, which will be described later.

Meanwhile, in the case where the region to which writing is to be performed is unformatted (see YES route for step SE15), the zero-clearing part 25 writes zero data (all zero) in step SE17.

Then, in step SE19, the zero-clearing part 25 determines whether or not only the formatting status of the formatting status storage region 41 in the cache memory 7 is to be updated to “done”.

In the case where the formatting status management table 46 in the SSD 11 as well as the formatting status storage region 41 in the cache memory 7 is to be updated (see NO route for step SE19), the process proceeds to step SE21. Then, the SSD storage processing part 23 updates the formatting status of the formatting status management table 46 in the formatting status storage region 45 in the SSD 11 to “done”, and the process proceeds to step SE23, which will be described later.

Meanwhile, in the case where only the formatting status of the formatting progress status management table 42 in the cache memory 7 is to be updated to “done” (see YES route for step SE19), the process proceeds to step SE23, which will be described later.

Then, in step SE23, the cache memory storage processing part 21 updates the formatting status of the formatting progress status management table 42 in the formatting status storage region 41 in the cache memory 7 to “done”.

In step SE25, the I/O processing part 29 processes the operation I/O (Write (1) or Write (2)) extracted from the queue in step SE5.

Then, in step SE27, the I/O processing part 29 determines whether or not a request remains in the writing request queue.

In the case where a request remains in the writing request queue (see YES route for step SE27), the process returns to step SE5. In step SE5, the next request is processed.

Meanwhile, in the case where no request remains in the writing request queue (see NO route for step SE27), the process is terminated.

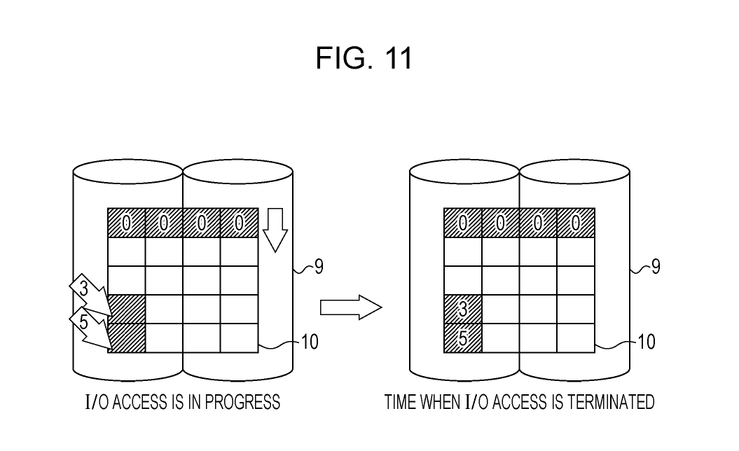

Next, the function of the specific range calculating part 31 illustrated in FIG. 2 will be explained with reference to FIG. 11.

FIG. 11 is a diagram illustrating an example of a process performed by the specific range calculating part 31 in an embodiment.

As illustrated in FIG. 11, the formatting processing unit 17 performs initial formatting processing only for a specific range of a region allocated to the logical volume 10. Thus, the operation server 51 or the like is capable of quickly accessing the logical volume 10.

That is, by limiting the region of the logical volume 10 for which initial formatting is performed, the formatting processing unit 17 allows the logical volume 10 to be quickly used.

For example, in the example of FIG. 11, in the case where the HDD 9 in the initial state is to be formatted, the zero-clearing part 25 of the formatting processing unit 17 formats only two-fifths of the entire HDD 9 from the beginning. At this time, the zero-clearing part 25 skips a processing block to which zero data has already been written, as described above.

Formatting processing for the leading region of the logical volume 10 is performed earlier than the other regions since the leading region of the logical volume 10 is likely to be used at first.

After initial formatting is performed, the operation server 51 writes values “3” and “5” to processing blocks for which formatting has not been performed in the logical volume 10, and the zero-clearing part 25 performs formatting of only the processing blocks to which the I/O access has been made. Then, after formatting is performed, the I/O processing part 29 writes the values “3” and “5” to the processing blocks.

In this case, the specific value range for which initial formatting is to be performed is calculated by the specific range calculating part 31 illustrated in FIG. 2 on the basis of the logical volume 10 designated by an operator and the use start time.

In more detail, the specific range calculating part 31 calculates the time to be used for formatting processing (time allowed for formatting), as explained with reference to a method of FIG. 12. Then, the specific value range for formatting is calculated on the basis of the capacity of the logical volume 10, the time allowed for formatting, and the assumed formatting processing speed.

Then, the zero-clearing part 25 performs formatting for the calculated specific value range from the leading block of the logical volume 10.

In the case where formatting processing has not been completed by the time when the use start time designated by an operator, the zero-clearing part 25 stops the formatting processing.

By the processing described above, by performing, by the formatting processing unit 17, initial formatting processing for only the specific value range of the entire region allocated to the logical volume 10, disk access to the logical volume 10 in an early stage is achieved.

Alternatively, in the case of the storage device 3 combined with thin-provisioning in which the capacity of the logical volume 10 is virtualized, the specific range calculating part 31 may perform allocation of the logical volume 10 for a specific value range and formatting may be performed for the allocated logical volume 10.

Hereinafter, a process performed by the specific range calculating part 31 will be explained with reference to FIG. 12.

FIG. 12 is a method illustrating an example of a process performed by the specific range calculating part 31 in an embodiment.

In step SF1, an operator input the capacity of the logical volume 10 to be created.

In step SF3, the operator inputs the time at which the logical volume 10 starts to be used (use start time).

In step SF5, the specific range calculating part 31 acquires the current time.

Then, in step SF7, the specific range calculating part 31 acquires an assumed formatting processing speed. For example, the assumed formatting processing speed is acquired by the disk array configuration information management unit 19 or the like.

In step SF9, the specific range calculating part 31 calculates the time allowed for formatting. Here, the time allowed for formatting is calculated as follows:

(Time allowed for formatting)=(use start time designated in step SF3)=(current time acquired in step SF5).

In step SF11, the specific range calculating part 31 calculates a set value range to be formatted.

Here, the set value range to be formatted is calculated as follows:

(Set value range to be formatted)=(capacity of logical volume 10 designated in step SF1)×(time allowed for formatting calculated in step SF8)/(assumed formatting processing speed acquired in step SF7).

In step SF13, the specific range calculating part 31 displays formatting rate.

Here, the formatting rate is calculated as follows:

(Formatting rate)=(set value range to be formatted calculated in step SF11)/(capacity of logical volume 10).

In step SF15, the zero-clearing part 25 moves to the beginning of the logical volume 10.

In step SF17, the zero-clearing part 25 continues to perform the formatting processing.

In step SF19, the zero-clearing part 25 determines whether or not the use start time designated by the operator in step SF3 is reached.

In the case where the use start time is reached (YES route for step SF19), the process proceeds to step SF23. In step SF23, the zero-clearing part 25 terminates the formatting processing.

Meanwhile, in the case where the use start time is not reached (NO route for step SF19), the specific range calculating part 31 determines whether or not the set value range to be formatted is reached in step SF21.

In the case where the set value range to be formatted is not reached (NO route for step SF21), the process returns to step SF17. In step SF17, the zero-clearing part 25 continues to perform the formatting processing.

Meanwhile, in the case where the set value range to be formatted is reached (YES route for step SF21), the formatting processing is terminated in step SF23.

The specific value range may be designated on the basis of the rate relative to the entire capacity of the logical volume 10 (for example, k %), instead of the capacity of the logical volume 10.

In this case, initial formatting is performed for a region to the rate (k %) from the leading block of the logical volume 10.

After the initial formatting is performed, in the case where an operation I/O for the logical volume 10 occurs, the I/O monitoring part 27 monitors the access rate for the logical volume 10.

Then, the specified rate calculating part 33 (see FIG. 2) determines whether or not the remaining region of the logical volume 10 is to be formatted in advance before the operation I/O actually occurs.

In the case where the remaining region of the logical volume 10 is to be formatted in advance, the zero-clearing part 25 performs formatting processing in the background during the time in which the number of operation I/Os is small.

Alternatively, formatting processing is not performed until a writing request occurs in a processing block, and in the case where reading (Read) access occurs in the processing block before formatting is performed, zero data may be returned.

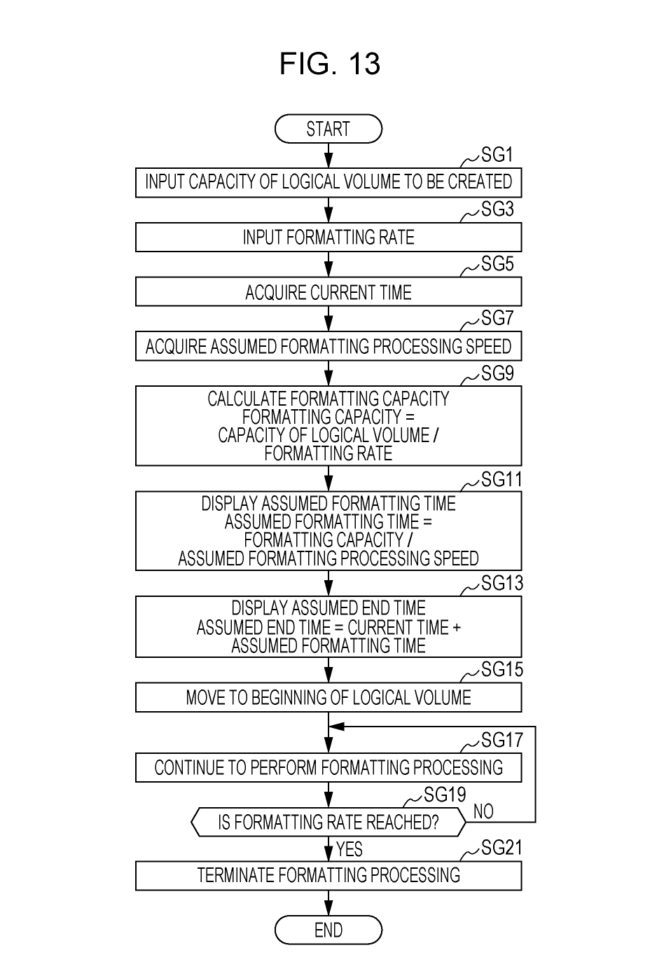

Hereinafter, a process performed by the specified rate calculating part 33 will be explained with reference to FIG. 13.

FIG. 13 is a method illustrating an example of a process performed by the specified rate calculating part 33 in an embodiment.

In step SG1, an operator inputs the capacity of the logical volume 10 to be created.

In step SG3, the operator specifies the rate of the logical volume 10 for which initial formatting is to be performed.

In step SG5, the specified rate calculating part 33 acquires the current time.

In step SG7, the specified rate calculating part 33 acquires an assumed formatting processing speed. For example, the assumed formatting processing speed is acquired by the disk array configuration information management unit 19 or the like.

In step SG9, the specified rate calculating part 33 calculates the formatting capacity. Here, the formatting capacity is calculated as follows:

Formatting capacity)=(capacity of logical volume 10 designated in step SG1)×(formatting rate specified in step SG3).

In step SG11, the assumed formatting time is displayed.

Here, the assumed formatting time is calculated as follows:

(Assumed formatting time)=(formatting capacity calculated in step SG9)/(assumed formatting processing speed calculated in step SG7).

In step SG13, the specified rate calculating part 33 displays an assumed end time.

Here, the assumed end time is calculated as follows:

(Assumed end time)=(current time acquired in step SG5)+(assumed formatting time calculated in step SG11).

In step SG15, the zero-clearing part 25 moves to the beginning of the logical volume 10.

In step SG17, the zero-clearing part 25 continues to perform the formatting processing.

In step SG19, the zero-clearing part 25 determines whether or not the initial formatting rate specified by the operator in step SG3 is reached.

In the case where the initial formatting rate is reached (YES route for step SG19), the process proceeds to step SG21. In step SG21, the formatting processing is terminated.

Meanwhile, in the case where the initial formatting rate is not reached (NO route for step SG19), the process returns to step SG17. In step SG17, the zero-clearing part 25 continues to perform the formatting processing.

According to an embodiment, as the place where formatting status management information is stored, the SSD 11 is used instead of a storage region of the cache memory 7. Then, only part of the formatting status management information to be used for management of the progress status is stored in the cache memory 7.

Accordingly, the memory capacity of the cache memory 7 provided in the storage device 3 is not increased, and by using a free space of the cache memory 7 in order to increase the degree of multiplexing of formatting processing for the logical volume 10, the formatting processing time is reduced.

In related art, the processing for managing the formatting progress status is performed only using a region of the cache memory 7. The map of all the address regions of the HDD 9 to be formatted is created on the cache memory and operation is performed.

Thus, the number of processing operations that may be processed at the same time is limited by the size of the region of the cache memory 7 to be used.

Meanwhile, in an embodiment, the entire map for managing the formatting status is created in the SSD 11, part of the map is temporarily arranged in the cache memory 7, and management of the formatting progress status is performed.

As described above, by arranging all the information, which is expanded in the cache memory 7 in the related art, into the SSD 11 and arranging only part of the information into the cache memory 7, the use region of the cache memory 7 is reduced. Accordingly, formatting progress status management regions for a plurality of HDDs 9 may be created on the cache memory 7, and the degree of multiplexing (more precisely, the number of formatting processing operations for a plurality of HDDs that may be performed at the same time) may be increased.

Furthermore, since the zero-clearing part skips a processing block that has already been zero-cleared, the formatting processing time is further reduced.

Furthermore, according to an embodiment, by performing initial formatting for only a certain range, instead of performing initial formatting for the entire logical volume 10, the time until the logical volume 10 becomes usable is reduced.

Thus, the storage device 3 including a large-capacity logical volume 10 may start to be used earlier than the related art.

At this time, by performing formatting processing for an allowed period of time until the use start time, the original disk access performance is ensured for a region to be used in the intermediate future.

Furthermore, even in an environment such as thin provisioning, in which a storage pool, which is a virtualized capacity of the logical volume 10, is adopted, allocation of only a specific value range of the logical volume 10 is performed in advance, and the original disk access performance is ensured.

### (B) Others

Apart from the embodiment described above, various modifications may be made without departing from the scope of the embodiment.

in the embodiment described above, the space for the formatting status storage region 45 is ensured in the SSD 11. However, the formatting status storage region 45 may be created in a medium that is different from the SSD 11.

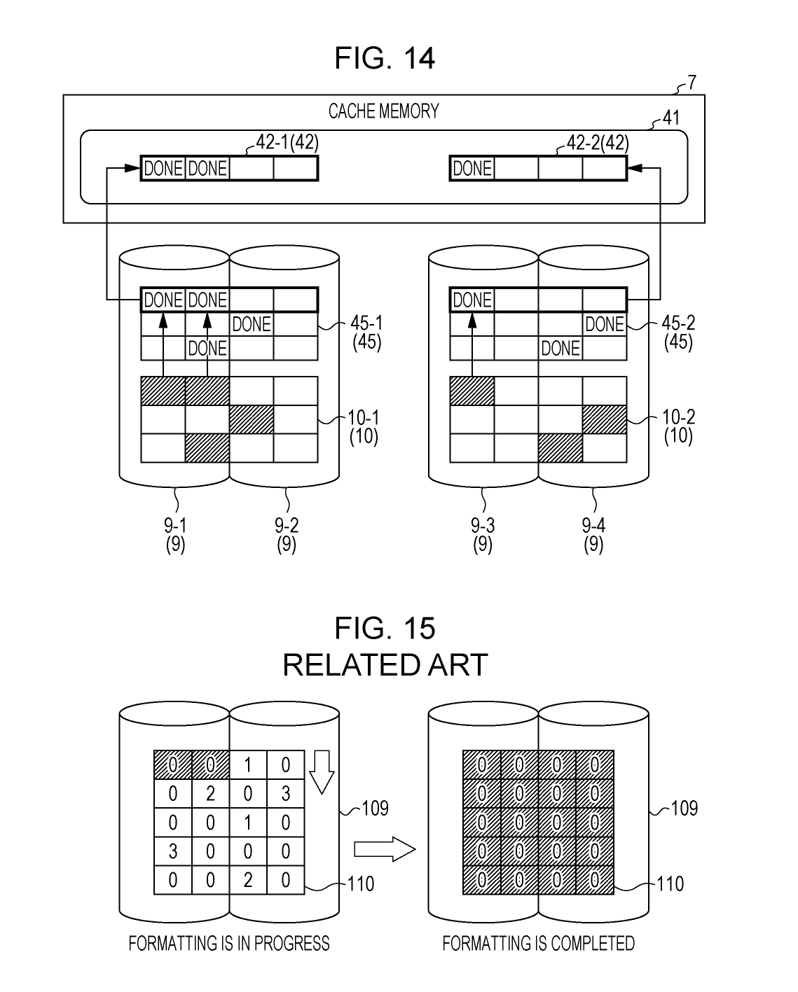

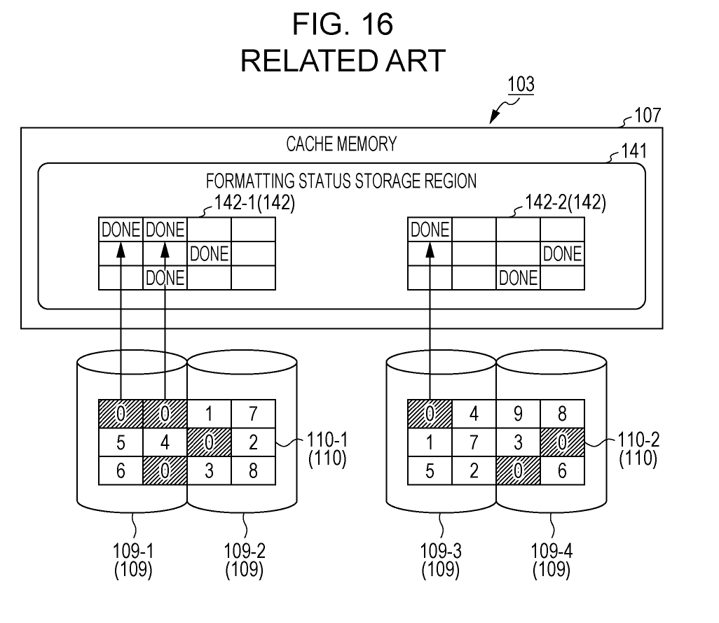

For example, the formatting status storage region 45 may be stored in a leading region of the logical volume 10. Such an example will be illustrated in FIG. 14.

FIG. 14 is a diagram illustrating a process performed by the formatting processing unit 17 according to a variation of an embodiment.

In the example illustrated in FIG. 14, a leading region of the logical volume 10 is ensured as the formatting status storage region 45. In this region, formatting information of a storage area of the logical volume 10 is stored.

According to the variation of the embodiment, since the SSD 11 is not to be added to the storage device 3, the production cost of the storage device 3 is reduced.

The degree of multiplexing of formatting processing for the logical volume 10 is increased, and I/O processing after formatting is performed may be quickly started.

In order to implement the functions as the formatting processing unit 17, the cache memory storage processing part 21, the SSD storage processing part 23, the zero-clearing part 25, the I/O monitoring part 27, the I/O processing part 29, the specific range calculating part 31, and the specified rate calculating part 33, a program stored in an internal storage device (not illustrated) is executed by a microprocessor (in this embodiment, the CPU 5) of a computer.

At this time, the computer may read a program recorded in a storage medium and execute the read program.

A program for implementing the functions as the formatting processing unit 17, the cache memory storage processing part 21, the SSD storage processing part 23, the zero-clearing part 25, the I/O monitoring part 27, the I/O processing part 29, the specific range calculating part 31, and the specified rate calculating part 33 is provided in a state in which the program is recorded in a computer-readable storage medium such as, for example, a flexible disk, a CD (a CD-ROM, a CD-R, a CD-RW, or the like), a DVD (a DVD-ROM, a DVD-RAM, a DVD-R, a DVD+R, a DVD-RW, a DVD+RW, an HD DVD, or the like), a Blu-ray disc, a magnetic disk, an optical disk, a magneto-optical disk, or the like. The computer reads the program from the storage medium, transfers and stores the read program into an internal storage device or an external storage device, and uses the program. Alternatively, the program may be recorded in a storage device (storage medium) such as, for example, a magnetic disk, an optical disk, a magneto-optical disk, or the like, and may be supplied from the storage device via a communication path to the computer.

In this embodiment, the concept of a computer includes hardware and an operating system and the computer means hardware operating under the control of an operating system. Furthermore, in the case where an application program solely operates hardware without using an operating system, the hardware itself corresponds to the computer. Hardware includes at least a microprocessor, such as a CPU, and a unit for reading a computer program recorded in a storage medium. In this embodiment, the storage device 3 has a function as a computer.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A management apparatus that performs initialization of a storage region of a storage medium, the management apparatus comprising:
a first storage area that stores a first information representing an initialization status of the storage region of the storage medium;
a second storage area that stores a second information representing an initialization progress status of the storage region of the storage medium;
an initializing unit that performs initialization of the storage medium based on the second information; and
a storage processing unit that updates the first information based on the second information which reflects the initialization progress status.

2. The management apparatus according to claim 1, further comprising:
a calculating unit that calculates a range of the storage medium for which initialization is to be performed; and
an initializing unit that performs initialization of the range of the storage medium.

3. The management apparatus according to claim 1, wherein the storage region of the storage medium is divided into a plurality of blocks, and the initializing unit performs the initialization for every unit of the blocks.

4. The management apparatus according to claim 1, wherein the second storage area stores a plurality of pieces of second information, and the initializing unit performs the initialization of a plurality of storage regions by multiplexing in accordance with the plurality of pieces of second information.

5. The management apparatus according to claim 2, wherein the calculating unit calculates the range based on a volume capacity of the storage medium, time allowed for initialization, and performance information.

6. The management apparatus according to claim 2, wherein the calculating unit calculates the range based on a rate relative to the entire capacity of the storage medium.

7. A storage device comprising:
a storage medium including a storage region;
a first storage area that stores a first information representing an initialization status of the storage region of the storage medium;
a second storage area that stores second information representing an initialization progress status of the storage region of the storage medium;
an initializing unit that performs initialization of the storage medium based on the second information; and
a storage processing unit that updates the first information based on the second information which reflects the initialization progress status.

8. The storage device according to claim 7, further comprising:
a calculating unit that calculates a range of the storage medium for which initialization is to be performed; and
an initializing unit that performs initialization of the range of the storage medium.

9. An initialization method for a storage medium executed by a computer, the initialization method comprising:
storing, in a first storage area, a first information representing an initialization status of a storage region of the storage medium;
storing, in a second storage area, a second information representing an initialization progress status of the storage region of the storage medium;
performing initialization of the storage medium based on the second information; and
updating the first information based on the second information which represents the initialization progress status.

10. The initialization method according to claim 9, further comprising:
calculating a range of the storage medium for which initialization is to be performed; and
performing initialization of the range of the storage medium.
